(19) United States
(12) Patent Application Publication
(10) Pub. No.: US 2021/0383008 A1
(43) Pub. Date: Dec. 9, 2021

(54) METHODS AND SYSTEMS FOR ALTERING ACCESS RIGHTS SET ON DIGITAL DOCUMENTS BASED ON TEMPORAL EVENTS

(71) Applicant: i2Chain, Inc., San Ramon, CA (US)

(72) Inventors: Mark Steven MANASSE, San Francisco, CA (US); Sanjay JAIN, Sammamish, WA (US); Ajay JOTWANI, San Ramon, CA (US)

(21) Appl. No.: 17/339,684

(22) Filed: Jun. 4, 2021

Related U.S. Application Data
(60) Provisional application No. 63/034,765, filed on Jun. 4, 2020.

(51) Int. Cl. G06F 21/62; G06N 20/00; G06F 16/93

(52) U.S. Cl. CPC G06F 21/6218; G06F 16/93; G06N 20/00

(57) ABSTRACT

Methods and systems for altering access rights set on a digital document, based on the triggering temporal events are described. The method performed by server system includes accessing access rights information associated with a digital document stored by the publisher in a database. The access rights information includes one or more access rights set on the digital document and access rights alteration rules. The method includes restricting access to the digital document for one or more recipients in response to receiving access requests from one or more recipients based, at least in part, on one or more access rights. The method includes monitoring occurrences of a plurality of the triggering temporal events based, at least in part, on a machine learning (ML) model. The method further includes altering one or more access rights set on the digital document based, at least in part, on the access rights alteration rules.

### TECHNICAL FIELD

The present disclosure relates to the field of data storage and access permissions and, more particularly to, electronic methods and complex processing systems for altering, based on the temporal events, the access rights such as the ability to read, modify, print, share, etc., set on the digital documents.

### BACKGROUND

Currently, it is quite common to store and access content/data/information via online content management systems. An online file-sharing system provides a way to store and access information, such as documents, data, photos, and video in a cloud storage rather than storing the information locally on a device hard drive or on a removable media (for instance, Compact Disc (CDs), Digital Versatile Discs (DVDs), Universal Serial Bus (USB) drives and Blu-Ray disks). Further, an online file-sharing system allows people to access the information from any device that has access to the internet connection and by anyone who is given the appropriate data access rights (DAR). The data access rights allow/deny people to read, update, print, further share, etc., the information. Specifically, the permissions define the degree of control given to a digital document's recipients. For instance, a user may have permission to view a report but not to modify or share the report. Accordingly, the DAR plays an important role in information security and compliance.

In conventional methods, providing data access rights to the recipients is a static and manual process. The data access rights are set by the publisher/owner of the document/information at the time of creation of the document. The rules for providing data access rights are very static and have to be set for each of the documents published by the owner based on the type of the documents and the severity of the secrecy to be maintained. The access rights set at the time of a document creation may not be quite relevant once certain specific temporal events have occurred. E.g., a document containing the quarterly report of the next quarter of a company will have many fewer secrecy requirements once the quarterly results are announced by the company.

In light of the above discussion, there is a need for methods and systems for altering the access rights set on digital documents in a dynamic manner, i.e. based on the occurrence of certain specific temporal events.

### SUMMARY

Various embodiments of the present disclosure provide methods and systems for altering the access rights set on a digital document based on temporal events.

In an embodiment, a computer-implemented method is disclosed. The computer-implemented method performed by a server system associated with an application installed on a user device associated with a publisher includes accessing access rights information associated with a digital document stored by the publisher in a database. The access rights information includes one or more initial access rights set on the digital document and the access rights alteration rules which specify the triggering events. The method includes enforcing access rights on the digital document for one or more recipients in response to receiving access requests from one or more recipients based on the access rights set on the digital document, and the method also includes monitoring occurrences of a plurality of the triggering temporal events, e.g., using artificial intelligence (AI)/machine learning (ML) models. Upon successful detection of at least one triggering temporal event, the method includes determining the appropriate alterations based on the access rights alteration rules, and then altering one or more access rights set on the digital document.

In another embodiment, a server system is disclosed. The server system includes a memory configured to store instructions, a communication interface, a processor in communication with the memory and the communication interface, and the processor is configured to execute the instructions stored in the memory and thereby cause the server system to access the access rights information associated with a digital document stored by the publisher. The information includes one or more access rights set on the digital document and the access rights alteration rules. The server system is further caused to enforce access rights to the digital document for one or more recipients in response to receiving access requests from the recipients based on the access rights set on the document, and monitor occurrences of a plurality of the triggering temporal events based, at least in part, on one or more AI/ML models. Upon successful detection of at least one triggering temporal event, the method includes determining the appropriate alterations based on the access rights alteration rules, and then altering one or more access rights set on the digital document.

### BRIEF DESCRIPTION OF THE FIGURES

For a more complete understanding of example embodiments of the present technology, reference is now made to the following descriptions taken in connection with the accompanying drawings in which:

FIG. 1 is an example representation of an environment related to at least some examples of the present disclosure;

FIG. 2 is a simplified block diagram representation of Linux servers and a server system with additional aspects, in accordance with an embodiment of the present disclosure;

FIG. 3 is a flow chart for a process flow for training a machine learning (ML) model for classifying the triggering temporal events, in accordance with an embodiment of the present disclosure;

FIG. 4 is a sequence flow diagram for setting access rights on digital documents and restricting the access to the digital documents to recipients, in accordance with an example embodiment of the present disclosure;

FIG. 5 is a sequence flow diagram for monitoring triggering temporal events and determining access rights alteration rules to be applied, in accordance with an example embodiment of the present disclosure;

FIG. 6 is a flow diagram of a computer-implemented method for altering access rights set on a digital document based on the triggering temporal events, in accordance with an embodiment of the present disclosure; and

FIG. 7 is a simplified block diagram of an electronic device capable of implementing the various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various embodiments of the present disclosure provide methods, systems, electronic devices, and computer program products for automatically altering access rights set on a digital document based on the triggering temporal events. The technical problem in the existing solutions is that the setting of the initial access rights on a digital document and the subsequent alteration of the access rights are very manual processes. The publisher, owner, or whosoever that has the authority over the digital document may have to manually alter the access rights, based on the occurrence of an internal or external event. This process is cumbersome, inflexible, and may lead to a breach of confidential data.

More specifically, the present disclosure describes techniques and methodology for automatically altering one or more access rights set on a digital document based on an occurrence of at least one triggering temporal event. The alteration of the access rights may be performed based on the access rights alteration rules and the associated triggering events determined by a machine learning (ML) model. The present disclosure described herein is subjected to sharing digital documents between a publisher and multiple recipients. In some instances, the digital or original document may be shared with a single recipient. It is to be noted that the digital document refers to the content that existed at the beginning of a process or activity. It may also refer to an original piece of writing that was written recently and had not been published before.

In an example, the present disclosure describes a server system that is configured to perform alteration of one or more access rights set on a digital document, based on the detected triggering temporal events. The server system is configured to access the access rights information associated with a digital document stored by the publisher in a database. The publisher may be associated with a user device installed with an application provided by the server system for performing various operations described herein. The access rights information accessed by the server system includes one or more access rights set on the digital document and the access rights alteration rules. One or more access rights specify that one or more recipients are allowed/denied to write, share, print, download, etc., the digital document. The access rights alteration rules include information about a plurality of the triggering temporal events to be monitored. The access rights alteration rules specify how one or more access rights are to be altered based on the occurrence of at least one triggering temporal event, which could even be just a predetermined time schedule.

The server system is configured to allow/deny appropriate access to the digital document from one or more recipients, in response to a request received from the recipients. The rights may be imposed based on one or more access rights accessed by the server system. The request may be initiated by the recipients via a document viewer application installed on their respective user devices.

In one embodiment, the server system is trained to monitor occurrences of a plurality of the triggering temporal events based, at least in part, on a machine learning model (ML) and internal and/or external information. The information may be just one of a date, time, etc. The triggering temporal event maybe, but is not limited to, a political event, a social event, a financial event, a release event, a publishing event, and a product release event. The server system is configured to detect at least one triggering temporal event by utilizing the ML model and by interacting with one or more services such as calendar service, email service, news publishing service, etc.

Upon successful detection of at least one triggering temporal event, e.g., using artificial intelligence (AI)/machine learning (ML) models, the server system uses the access rights alteration rules to determine the appropriate alterations to be applied to one or more access rights set on the digital document. The ML model may be trained using previously labeled data mapping various internal and/or external information to the triggering temporal events. The ML model is trained to learn the patterns of the triggering temporal events.

In one example embodiment, the ML model may be implemented using a classification model. The classification model may be provided with internal and/or external information, e.g., news articles from specific sources, as the input and the classification model may output the corresponding triggering temporal event. The ML model is configured to learn the patterns of the triggering temporal events based on the internal and/or external information that is fed to ML model. Further, the server system modifies one or more access rights set on the digital document based on the access rights alteration rules and the triggering temporal event. An alteration may relax or further restrict one or more access rights set on the digital document.

Without in any way limiting the scope, interpretation, or application of the claims appearing below, technical effects of one or more of the example embodiments disclosed herein is provisioning access rights dynamically to shareable digital documents. The present disclosure eliminates the static nature of access rights by automating the process of altering the access rights set on a sharable digital document. Further, the present disclosure enables tracking of internal and external events that result in alteration of the access rights. Alteration of the access rights may allow/deny additional permissions to the document to the existing and/or to new recipients.

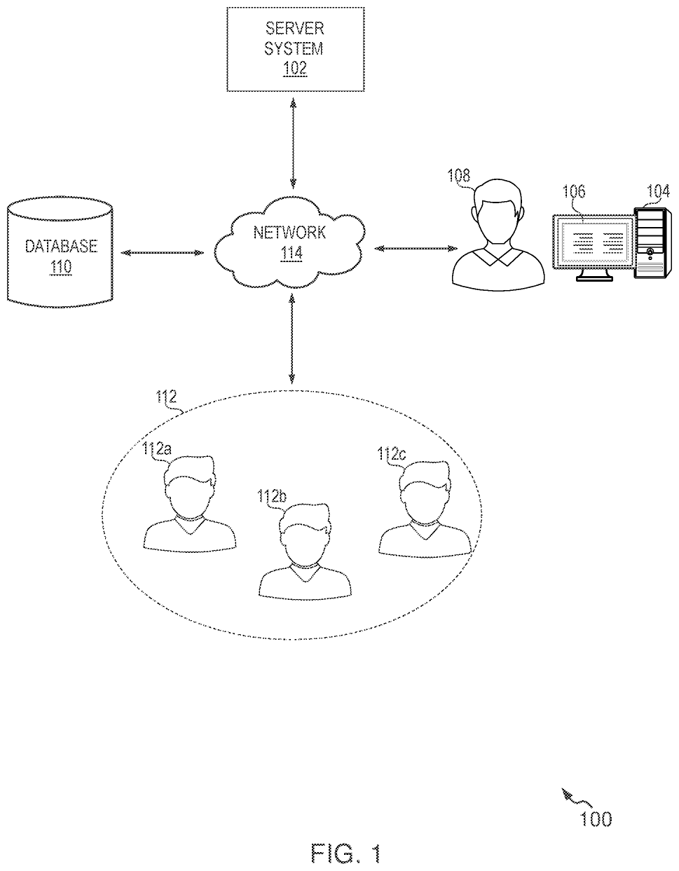

Various example embodiments of the present disclosure are described hereinafter with reference to FIGS. 1 to 7.

FIG. 1 is an example representation of an environment 100 related to at least some examples of the present disclosure. Although the environment 100 is presented in one arrangement, other embodiments may include the parts of the environment 100 (or other parts) arranged otherwise depending on, for example, for dynamically altering one or more access rights set on a digital document based on the triggering temporal events, etc. The environment 100 generally includes a server system 102, a user device 104 associated with a user 108 (interchangeably used the term “publisher” throughout the description), and a database 110 associated with and in communication with (and/or with access to) a network 114. The network 114 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among the entities illustrated in FIG. 1, or any combination thereof.

Various entities in the environment 100 may connect to the network 114 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. The network 114 may include, without limitation, a local area network (LAN), a wide area network (WAN) (e.g., the Internet), a mobile network, a virtual network, and/or another suitable public and/or private network capable of supporting communication among two or more of the entities illustrated in FIG. 1, or any combination thereof. For example, the network 114 may include multiple different networks, such as a private network made accessible by the server system 102, the user device 104, and the database 110 separately, and/or a public network (e.g., the Internet) through which the server system 102, the user device 104 and the database 110 may communicate. In some embodiments, the user device 104 and the database 110 may, for example, be connected to the server system 102 via various wireless means such as, cell towers, routers, repeaters, ports, switches, and/or other network components that include the Internet and/or a cellular telephone (and/or Public Switched Telephone Network (PSTN)) network, and which include portions of the network 114.

In one embodiment, the user device 104 may include any type or configuration of computing, mobile electronic, network, user, and/or communication devices that are or become known or practicable. Examples of the user device 104 include a mobile phone, a smart telephone, a computer, a laptop, a PDA (Personal Digital Assistant), a Mobile Internet Device (MID), a tablet computer, an Ultra-Mobile personal computer (UMPC), a phablet computer, a handheld personal computer and the like. Each user device may include an ultrasound sensor, a global position satellite transceiver, WiFi transceiver, mobile telephone components, and/or any suitable combination thereof. In some embodiments, the user device 104 may include a device owned and/or operated by the user 108 of an online service. According to some embodiments, the user device 104 may communicate with the server system 102 via the network 114, such as to register with a service provider, upload or create a digital document, request access to the digital document, view and/or edit the digital document. The user device 104 can have unique device identifiers including MAC addresses, supported services/protocols, available ports, ports in use, etc.

The user or publisher 108 may be responsible for setting access rights that are given to various users within or outside an organization. The publisher 108 may specify restrictions that dictate access rights given to the recipients 112a-112c. As per the access rights, the recipients 112a-112c may be allowed or denied from viewing the digital document, commenting on the digital document, or further sharing of the digital document to a member or a non-member of the organization, among others.

In one embodiment, the database 110 may store digital documents and information related to the digital documents, for instance, publisher information, summary information, links to additional content about the digital documents, etc. In some instances, the information may also include a number of fields relating to access rights associated/inherent to the digital documents.

In one embodiment, the user device (e.g., the user device 104) is equipped with a document viewer application 106, interchangeably referred to as “mobile application” throughout the description. The document viewer application 106 enables the user 108 to log in and access shareable digital documents based on the access rights set on the document. The user device (e.g., the user device 104) may be any communication device having hardware components for enabling User Interfaces (UIs) of the document viewer application 106 to be presented on the user device (e.g., the user device 104). In one embodiment, the user device 104 may be associated with an owner or publisher of the digital document. The publisher 108 may utilize the document viewer application 106 on the user device 104 to set access rights on the digital document. The access rights may be set for one or more recipients such as the recipients 112a, 112b, and 112c. The recipients 112a-112c may have user devices (not shown) equipped with the document viewer application. The recipients 112a-112c are interchangeably referred to as “recipients 112” hereinafter.

In an embodiment, the server system 102 may implement the backend APIs corresponding to the document viewer application 106 which instruct the server system 102 to perform one or more operations described herein. In addition, the server system 102 should be understood to be embodied in at least one computing device in communication with the network 114, which may be specifically configured, via executable instructions, to perform as described herein, and/or embodied in at least one non-transitory computer-readable media. The document viewer application 106 is an application/tool resting at the server system 102.

In one embodiment, the server system 102 is configured to host and manage the document viewer application 106 and communicate with the user devices (e.g., the user device 104 and user devices associated with the recipients 112) for providing an instance of the document viewer application 106. The document viewer application 106 may facilitate, for example, a shareable digital document viewing service, the users may view, download, print the digital document using the document viewer application 106. In one example, only recipients who are allowed read & write access to the digital document can view and edit the digital document.

In one embodiment, the server system 102 is configured to control the access rights set on a digital document. The digital document may be accessible by one or more users in a collaborative manner. The server system 102 is configured to receive the access rights information regarding the digital document. The access rights information may include one or more access rights set on the digital document and the access rights alteration rules. The access rights alteration rules may include information about the triggering temporal events such as reception of an email, completion of a date, uploading of a document, and the like. In an embodiment, the server system 102 may be configured to register the user 108 and the recipients 112, via the document viewer application 106.

In one embodiment, one or more recipients (e.g., recipients 112) may send a request for viewing a digital document to the server system 102 using the document viewer application 106. The digital document may be stored in the database 110. The database 110 may be one of a local database associated with the user device 104, shared database accessible from one or more components associated in connection with the network 114, cloud storage, and the like.

The term “digital document” is used herein to describe objects produced or collaborated on by users, and it is not limited to media, such as audio-visual media. A digital document may be computer files that are capable of being produced by or edited or viewed using a productivity program or suite. Accordingly, the digital document may be editable or non-editable text, images, drawings and websites, among others.

In one embodiment, the digital document being accessed may be a corporate document such as an agreement, a contract, an official letter, a client letter, a corporate email, a software program, a report, a sales presentation, meeting notes, a memorandum, a partnership contract, a transcript, a product list, a product manual, an internal memo, a customer order, a human resource document, a performance review, a candidate interview report, a financial report, a document related to sales data, a patent application, a directory, a blueprint, a prototype specification, a piece of software source code, or a confidential document. In one embodiment, the electronic document may be a personal electronic document or belonging such as a medical record, a bill, a bank statement, a will, a monthly statement, a manuscript, a photo, an electronic identity document, a tax return, a business plan, a picture, an electronic painting, a piece of writing, a certificate, a sales receipt, an invoice, a lease agreement, a grant deed, a loan agreement, a letter, an electronic book, a work document, a song, an album, a business document delivered to a person over a data network, or a document a person stores in a data network. In another embodiment, the electronic document may be a commercial electronic document related to a purchase transaction such as a picture, an electronic book, a video, a song, an album, an invoice, a lease, an agreement, a letter, a user guide, a product specification, a manual, a receipt, a delivery notification, a message, a voice mail, a purchase order, or other transaction documents. Furthermore, the electronic document may include private information, personal identity, personal or corporate sensitive information, credit card information. In one embodiment, the digital document includes national security-related classified documents, e-mail trails, and/or presentations.

The server system 102 is configured to restrict the recipients from accessing the digital document based on one or more access rights set on the digital document by the publisher (e.g., user 108). The user 108 may impose temporal restrictions on further sharing and reading/modifying the original document. These restrictions are restored or disabled, for one or more recipients 112, when certain patterns of triggering events are identified. The server system 102 is configured to monitor the occurrences of a plurality of triggering temporal events based on the ML model. The ML model may be trained using previously labeled data of mapping various internal and/or external information to the triggering temporal events. The ML model is trained to learn the patterns of the triggering temporal events. In one example embodiment, the ML model may be provided with internal and/or external information, e.g., news articles from specific sources, as the input and the ML model may output the corresponding triggering temporal event. The ML model is configured to learn the patterns of the triggering temporal events based on the internal and/or external information fed to ML model during training process.

The server system 102 is configured to alter the one or more access rights based at least on the access rights alteration rules defined by the publisher 108. The alteration rules may include predefined triggering temporal events defined by the user 104. Based on the detection of the triggering temporal events, the server system 102 is configured to alter a set of access rights set on the digital document.

The server system 102 is configured to modify one or more access rights set on the digital document based on the access rights alteration rules. The access rights may be one of read: allowed/denied, write: allowed/denied, print: allowed/denied, download: allowed/denied, share within the organization: allowed/denied, share outside the organization: allowed/denied, etc.

In one embodiment, the server system 102 is configured to train the ML model for determining the access right alteration rules for triggering temporal events for a digital document. The access right alteration rules may include allowing all the access rights, allowing some access rights and denying other access rights, allowing access rights to only some members in an organization, and denying to others, etc.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of the environment 100 may perform one or more functions described as being performed by another set of systems or another set of devices of the environment 100.

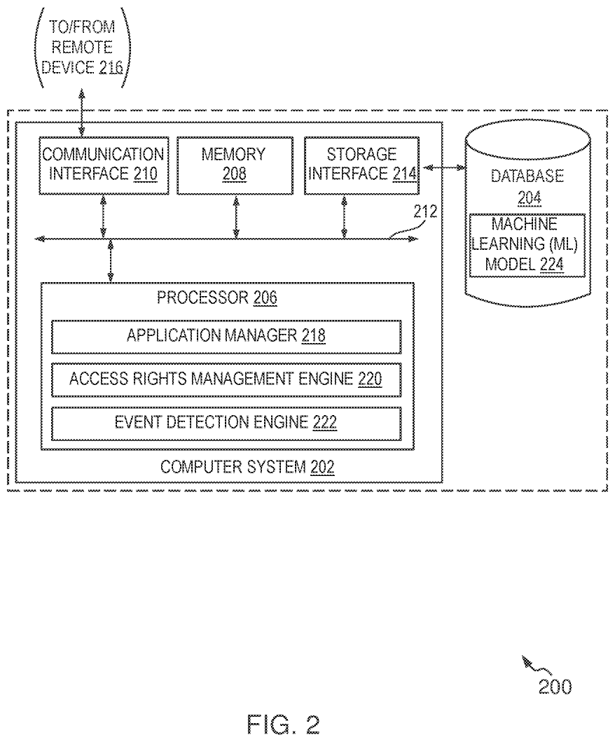

FIG. 2 is a simplified block diagram of a server system 200, in accordance with an embodiment of the present disclosure. For example, the server system 200 is similar to the server system 102 as described in FIG. 1. In some embodiments, the server system 200 is embodied as a cloud-based and/or SaaS-based (software as a service) architecture. The server system 200 is configured to set the access rights and alter the access rights on digital documents based on the triggering temporal events.

In one embodiment, the server system 200 includes a computer system 202 and a database 204 (i.e., it is similar to the database 110 as shown in FIG. 1). The computer system 202 includes at least one processor 206 for executing instructions, a memory 208, and a communication interface 210. The one or more components of the computer system 202 communicate with each other via a bus 212.

In one embodiment, the database 204 is integrated within the computer system 202. For example, the computer system 202 may include one or more hard disk drives as the database 204. A storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one embodiment, the database 204 may include a machine learning model 224.

The processor 206 includes suitable logic, circuitry, and/or interfaces to execute computer-readable instructions for facilitating the alteration of the access rights set on a digital document based on the triggering temporal events. Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In some embodiments, the memory 208 may be realized in the form of a database server or a cloud storage working in conjunction with the server system 200, without deviating from the scope of the present disclosure.

The processor 206 is operatively coupled to the communication interface 210 such that the processor 206 is capable of communicating with remote device 216 such as the user device 104, the database 110, etc., or with any entity connected to the network 114 (e.g., as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one embodiment, the processor 206 includes an application manager 218, access rights management engine 220, and event detection engine 222. It should be noted that components, described herein, can be configured in a variety of ways, including electronic circuitries, digital arithmetic and logic blocks, and memory systems in combination with software, firmware, and embedded technologies.

The application manager 218 includes suitable logic, circuitry, and/or interfaces to execute computer-readable instructions for facilitating and managing various operations of the document viewer application downloaded on various user devices such as the document viewer application 106 installed on the user device 104. The application manager 218 is configured to facilitate registration of a plurality of users, set access rights (only applicable for publishers/owners), view, share, download, and print various digital documents stored at one or more databases.

In one embodiment, the application manager 218 implements the backend APIs corresponding to the document viewer application which instruct the server system to perform one or more operations described herein. The APIs may act as the interfaces between the server system and the user device. The users may be able to perform various operations described herein, using the document viewer application installed on their user devices.

The application manager 218 enables a publisher (e.g., user 108) to upload or create a digital document that is stored in the database 204. The application manager 218 also provides a user interface on the user device 104 to set the access rights and the access rights alteration rules on the digital document.

The access rights management engine 220 includes suitable logic, circuitry, and/or interfaces to execute computer-readable instructions to manage access rights set on each digital document shared on the mobile application. The access rights management engine 220 receives information on access rights for each digital document. For example, based at least in part on the access rights set on the digital document, the document viewer application 106 may permit or deny a user access to the document or restrict one or more actions taken by the users of the organization with respect to the digital document.

In one embodiment, the access rights management engine 220 is configured to store the access rights information for a digital document that is expressed per recipient as an array of tuples (for example, read operation: allowed/denied, write operation: allowed/denied, print operation: allowed/denied, download operation: allowed/denied, share operation within the organization: allowed/denied, share operation outside the organization: allowed/denied).

In one embodiment, the access rights management engine 220 is configured to restrict the access to the digital document for one or more recipients in response to receiving requests for accessing the digital document. In one example, the recipients may be allowed to view the document, but may not be allowed to share, print, edit, or download the digital document. More illustratively, the access rights management engine 220 is configured to limit recipients of the digital document and further specify limitations to the access rights of the recipients.

The access rights management engine 220 may formulate a plurality of triggering temporal events to be monitored based, at least in part, on the access rights alteration rules of a digital document. The access rights alteration rules may include information about a plurality of triggering temporal events (e.g., external events) to be observed.

In one example, the access rights alteration rules may include information of the triggering temporal events such as receipt of an email, completion of a political event, a research paper being published, completion of the filing of a patent application, company quarterly report announcements, and the like. There may be a plurality of triggering temporal events corresponding to the digital documents stored in one or more databases. The access rights alteration rules may define a list of rule set of modifying access rights of each digital document upon detection of a particular triggering temporal event.

The event detection engine 222 includes suitable logic, circuitry, and/or interfaces to execute computer-readable instructions to monitor a plurality of the triggering temporal events based on internal and/or external information, and the ML model 224. The event detection engine 222 may communicate or interact with various third-party services such as, email service, calendar service, news service, financial data services, etc., and use the trained ML model 224 to monitor the plurality of the triggering temporal events. The plurality of the triggering temporal events may be either internal or external events. For example, the calendar service may notify the event detection engine 222 if the publisher 108 who shared the digital document is scheduled for a meeting with one or more other users. The event detection engine 222 may utilize the notification to indicate to the access rights management engine 220 that the digital document may be shared with one or more other users for the duration of the meeting.

Example of the triggering temporal events may be a political event, a social event, a financial event, a release event, a publishing event, a product release event, and the like. In other words, the event detection engine 222 is configured to detect an occurrence of at least one triggering temporal event associated with the digital document based on internal and/or external information and the access rights alteration rules associated with the digital document. The event detection engine 222 is responsible to observe specific triggering temporal events that trigger alteration of the access rights set for the digital document.

For instance, the event detection engine 222 may observe an email of an author until they receive confirmation of filing by their legal attorney. Thereupon, the rights inherent to the original document may be restored, in order to reflect the observable status changes. In another instance, the digital document (describing the technical details of a product) may be held as a secret and not forwarded outside a restricted group, until the product is actually released in the market. In yet another instance, the original document may be a patent application and the access rights may be limited to the engineering team charged with implementing and deploying the patent. They may not be granted the right to forward the original document to other teams until the patent application becomes public.

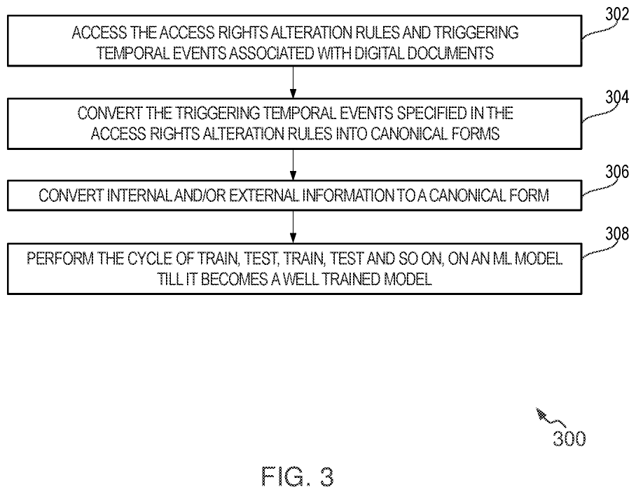

In one embodiment, the event detection engine 222 employs a machine learning (ML) model (e.g., ML model 224) trained to discover various triggering temporal events. In other words, the processor 206 is configured to train the ML model 224 based on historical triggering temporal events. The process flow of training the ML model 224 is discussed in detail in FIG. 3. One of ordinary skill in the art will be familiar with various machine learning techniques that may be employed in conjunction with the present disclosure, which include supervised, semi-supervised, and unsupervised learning based ML model.

In one example, the ML model 224 is a classification model. The ML model 224 may be a classification model implemented using one of a decision tree, logistic regression, k-nearest neighbors, support vector machines, Naive Bayes algorithms, etc.

During the execution phase, the event detection engine 222 is configured to receive information from internal and/or external sources, and make predictions about the likely occurrence of a triggering temporal events.

In an additional embodiment, when the event detection engine 222 is not able to determine an alteration triggering temporal event, the processor 206 may prompt the publisher or the user 108 to provide an input about the triggering temporal event. The processor 206 may be configured to further update the ML model 224 based on the input provided by the publisher or the user 108. The updating of the ML model 224 ensures that the server system 200 may determine the triggering temporal event if it occurs again in the future.

Thus, the processor 206 is configured to dynamically modify/alter the one or more access rights set on a digital document stored in the database 110 based on the detected triggering temporal events utilizing the ML model 224. The triggering temporal events may be detected based on internal and/or external information and the ML model 224. The external information may include just a date, time, or the like. The triggering temporal events may include completion of a date, completion of an event, receipt of an email, and the like. More illustratively, an altered access right may be counter or in conflict with the elements of the existing access rights of the digital document. For example, the altered access right may permit a user access to the digital document that was denied before.

The access rights management engine 220 is configured to modify/alter one or more access rights set on a digital document based on the triggering temporal events received from the event detection engine 222. In an example, the digital document may be a financial document with quarterly result included in it that has to be released on completion of the financial year. Here the completion of the financial year is the triggering temporal event and the event may be detected using internal and/or external information such as the date of completion of the financial year. The financial document may be made publicly available after the completion of the financial year, or publication of the financial results to the Securities and Exchange Commission (SEC). The triggering event may provide read, download, print, share, access permissions to anyone in the public domain. Therefore, after the completion of the financial year, the access rights management engine 220 is configured to relax all the access restrictions imposed on the financial document.

In one embodiment, the access rights alteration rules may be defined based on the designation given to employees in an organization, or selected people from a team who are involved in a project, and the like. For example, a group of inventors may have collaborated with designers for making a 3D model of a product that they are working on. A patent application may be being prepared for the invention. The patent application may be made available to one of the members of the design team. The access restrictions may be relaxed for all the team members only after an attorney has reviewed the patent application. Similarly, various examples may be included in the embodiment where selected members, only certain designated members may only be provided with access even after the alteration of the access rights.

In one embodiment, the processor 206 is configured to send a notification message to the recipients (e.g., recipients 112) of a digital document with altered access rights. For example, a digital document may be made available to some employees of an organization based on the triggering temporal event. The server system 200 may determine the triggering temporal events and alter one or more access rights set on a digital document. After altering the access rights, the server system 200 is configured to send notification messages to all the employees who may be able to access the digital document after the alteration of the access rights.

FIG. 3 is a flow chart 300 for a process flow for training an ML model (e.g., ML model 224) for classifying the triggering temporal events, in accordance with an embodiment of the present disclosure. The process depicted in the flow chart 300 may be executed by, for example, at least on one server system such as the server system 102. Operations of the flow chart 300, may be implemented by, for example, hardware, firmware, a processor, circuitry, and/or a different device associated with the execution of software that includes one or more computer program instructions.

At 302, the server system 102 accesses the access rights alteration rules and triggering temporal events associated with digital documents. The user (e.g., user 108) associated with the user device 104 may have set one or more access rights on one or more digital documents stored in the database 110. The user 108 may also have fed access rights alteration rules for one or more digital documents such that one or more access rights may be altered when one or more triggering temporal events occur.

For example, the user 108 may choose to withhold the permission to print a patent application until it has been reviewed, filed, or issued. Further examples of access rights may include but are not limited to, an indication of whether images or photos should be blocked in a document, a reference to a link that should be displayed with the document, etc. The access rights are subjected to one or more triggering temporal events that occur and by observing these triggering temporal events, the access rights may be altered.

At 304, the server system 102 may utilize one or more data pre-processing methods to convert the triggering temporal events specified in the access rights alteration rules into canonical forms suitable for feeding the data to the machine learning model as output. The canonical form refers to expressing the data in a mathematical form that is suitable to be fed to the machine learning model.

At 306, the server system 102 may utilize one or more data pre-processing methods to convert internal and/or external information to a canonical form suitable for feeding the data to the ML model 224 as input. Data pre-processing may include converting the data into a canonical form. The canonical form refers to expressing the data in a mathematical form that is suitable to be fed to the ML model 224.

In one example embodiment, the ML model 224 is a classification model that is trained using supervised learning. The supervised learning includes training a model using labeled data including an input mapped to an expected output. In the example above, the input is canonical internal and/or external information and the expected output is a canonical triggering temporal event. The classification model learns the features of input and its mapping to an output based on the labeled data that is fed to the model. The classification model may be implemented by one of logistic regression, decision trees, or random forest algorithms which facilitate the classification of an unseen output into a learned output. At 308, the server system 102 trains the ML model 224 by repeating a process of train, test, train, test etc., and once well trained it stores the trained ML model in the database 110.

In an embodiment, after the ML model 224 is trained, the server system 102 is configured to utilize the trained ML model 224 itself to modify/alter the access rights set on a digital document stored in a database, based on the triggering temporal events that are detected. The triggering temporal events may be detected by the ML model 224 based on internal and/or external information. The external information may include just a date, time, and the like. The triggering temporal event may include completion of a date, completion of an event, receipt of an email, and the like. For example, a company quarterly report document may be accessible (readable) to only executives before the quarterly results are announced but may become accessible (sharable and readable) to everyone in the world after the quarterly results have been announced. In the example, the announcement of the quarterly result is the triggering temporal event. Based on the occurrence of the triggering temporal event, the access rights set on the quarterly result document may be completely altered.

In an example, the digital document may be a research paper that has to be revealed in a seminar. Here, the completion of the seminar is the triggering event that may provide read, download, print, share, access permissions to anyone in the public domain, making the research paper publicly available. Therefore, after the completion of the seminar, the ML model may classify the triggering temporal event as a publishing event. Then, based on the alteration rules known to the server system 102, the server system may set more appropriate/relaxed access rights on the research paper. In one embodiment, the alteration rule may be a “restore all” alteration. The server system 102 may grant all the access rights set on the research paper based on the event detected by the ML model 224.

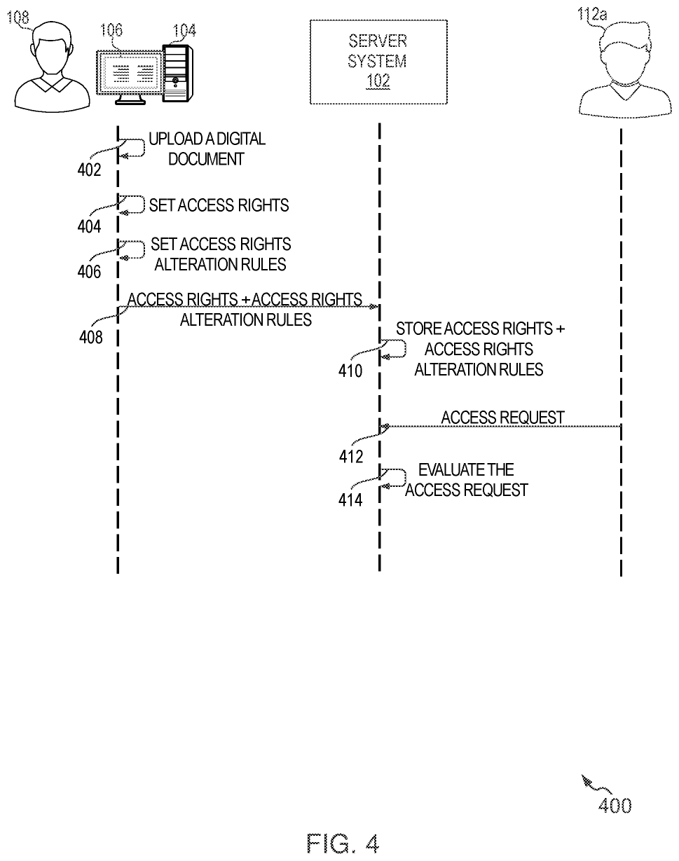

FIG. 4 is a sequence flow diagram 400 for setting access rights on digital documents and restricting the access of the digital documents form recipients, in accordance with an example embodiment of the present disclosure. The sequence of operations of the sequence flow diagram 400 may not be necessarily executed in the same order as they are presented. Further, one or more operations may be grouped and performed in form of a single step, or one operation may have several sub-steps that may be performed in parallel or in a sequential manner.

At 402, a publisher or the user 108 uploads a digital document (e.g., a sensitive file) on the database 110.

At 404, the user 108 sets the access rights associated with the digital document via a user interface. In other words, the user 108 sets permissions that specify the privileges given to a recipient in accessing the digital document. The user 108 may utilize the document viewer application 106 installed on the user device to set the access rights to be imposed on the digital document.

In one example, user ‘X’ has permitted user ‘A’ to read/write the digital document and user ‘X’ has permitted user ‘B’ only to read the digital document.

At 406, the user 108 also sets the access rights alteration rules, which specify the triggering temporal events, for the digital document via a user interface. In the above example, user ‘X’ allows read/write access rights to user ‘B’ upon a detection of a triggering temporal event (such as, product launch).

At 408, the access rights and the access rights alteration rules, which include the triggering temporal events, associated with the digital document are sent to the server system 102.

At 410, the server system 102 stores the access rights and the access rights alteration rules, which include the triggering temporal events, for the digital document in the database 110.

At 412, the server system 102 receives an access request from a recipient 112a for accessing the digital document.

At 414, the server system 102 evaluates the access request based on the recipient's identity and the access rights set on the digital document. The server system 102 determines whether to permit the user the requested access (e.g., annotation access) to the digital document or not. In one example, the recipient may belong to a domain name that is granted annotation (provide feedback) access to the digital document. If the server system 102 determines that the recipient is to be granted annotation access, the server system 102 allows annotation access to the digital document. After the annotation access is allowed, the recipient may annotate the digital document. If a negative annotation access determination is made, the server system 102 denies annotation access to the digital document.

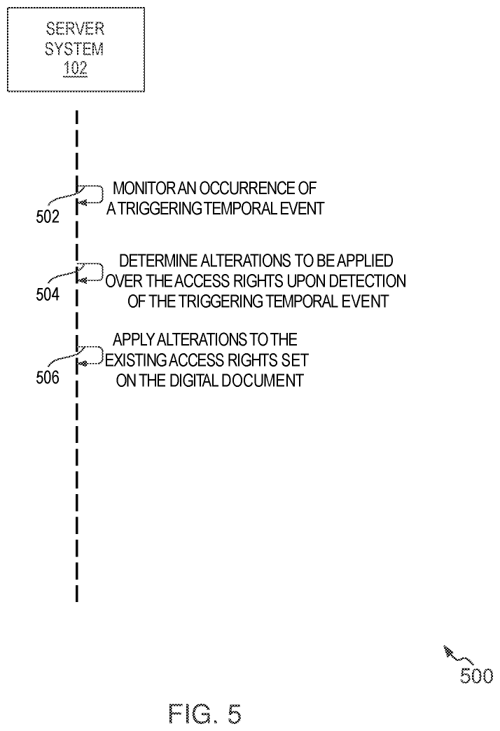

FIG. 5 is a sequence flow diagram 500 for monitoring triggering temporal events and determining access rights alteration rules to be applied, in accordance with an example embodiment of the present disclosure. The sequence of operations of the sequence flow diagram 500 may not be necessarily executed in the same order as they are presented. Further, one or more operations may be grouped and performed in form of a single step, or one operation may have several sub-steps that may be performed in parallel or in a sequential manner. The flow diagram 500 is initiated after receiving an access request for accessing the digital document from a recipient 112a.

At 502, the server system 102 monitors an occurrence of a triggering temporal event using internal/external information and an ML model (e.g., ML model 224). The ML model 224 may be trained to detect the occurrence of a triggering event based on the internal/external information. The server system 102 may access the internal and/or external information for detecting the triggering temporal event on periodic basis.

At 504, upon successful detection of the occurrence of a triggering temporal event, the server system 102 determines the alterations to be applied over the access rights set on the digital document based on the access rights alteration rules.

At 506, the server system 102 applies the alteration(s) (e.g., allowing annotation access right to a particular user) to the existing access rights set on the digital document.

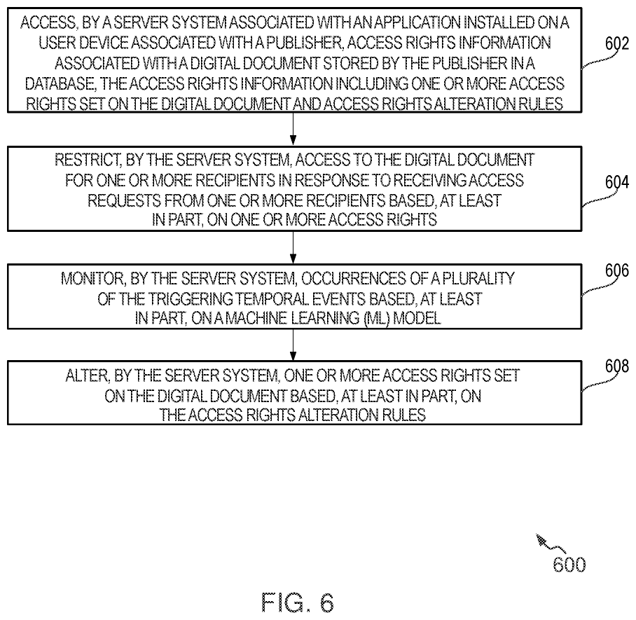

FIG. 6 is a flow diagram of a computer-implemented method 600 for altering access restrictions imposed on a digital document based on the triggering temporal events, in accordance with an embodiment of the present disclosure. The method 600 depicted in the flow diagram may be executed by, for example, at least one server system such as the server system 102. Operations of the flow diagram of method 600, and combinations of operation in the flow diagram of method 600 may be implemented by, for example, hardware, firmware, a processor, circuitry, and/or a different device associated with the execution of software that includes one or more computer program instructions. The method 600 starts at operation 602.

At the operation 602, the method 600 includes accessing access rights information associated with a digital document stored by the publisher at the database 110. The server system 102 is associated with an application (e.g., document viewer application 106) installed on the user device (e.g., user device 104) associated with the publisher 108. The access rights information includes one or more access rights set on the digital document and the access rights alteration rules. The one or more access rights specify that the one or more recipients 112a-112c are allowed/denied to at least one of: write, share, print and download the digital document. The access rights alteration rules include information of a plurality of the triggering temporal events to be monitored. The access rights alteration rules specify that alteration of one or more access rights is to be performed based on the occurrence of at least one triggering temporal event or a predetermined time-schedule (for example, a particular timestamp).

At operation 604, the method 600 includes restricting access to the digital document for one or more recipients (e.g., recipients 112) in response to receiving access requests from one or more recipients 112 based, at least in part, on one or more access rights set on the document. The request may be initiated by the recipients 112 via the document viewer application 106 installed on their respective user devices.

At operation 606, the method 600 includes monitoring occurrences of a plurality of the triggering temporal events based, at least in part, on a machine learning (ML) model.

At operation 608, the method 600 includes altering one or more access rights set on the digital document based, at least in part, on the access rights alteration rules. The altering the one or more access rights set on the digital document may further include altering a set of access rights for at least one or more existing recipients of the digital document based on the access rights alteration rules and granting the one or more access rights to one or more new recipients of the digital document based on the access rights alteration rules.

The sequence of operations of the method 600 need not be necessarily executed in the same order as they are presented. Further, one or more operations may be grouped and performed in form of a single step, or one operation may have several sub-steps that may be performed in parallel or a sequential manner.

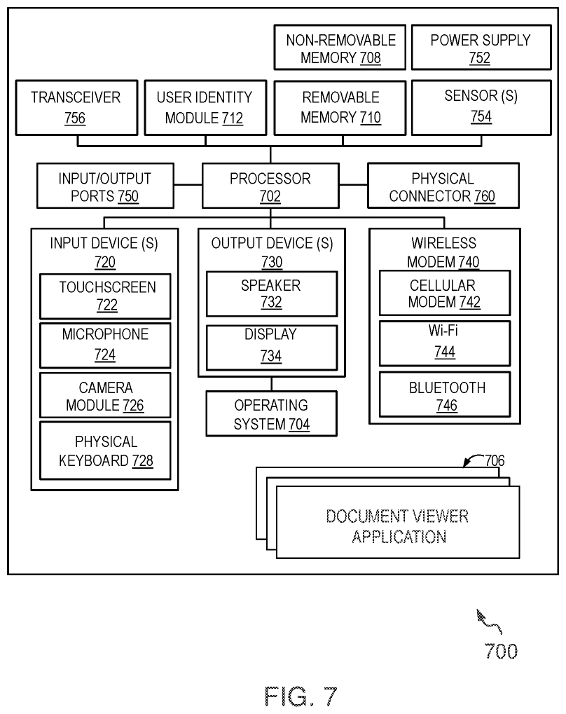

FIG. 7 shows a simplified block diagram of an electronic device 700 capable of implementing the various embodiments of the present disclosure. The electronic device 700 may be an example of the user device 104 shown in FIG. 1. It should be understood that the electronic device 700 as illustrated and hereinafter described is merely illustrative of one type of device and should not be taken to limit the scope of the embodiments. As such, it should be appreciated that at least some of the components described below in connection with the electronic device 700 may be optional and thus in an example embodiment may include more, less, or different components than those described in connection with the example embodiment of the FIG. 7. As such, among other examples, the electronic device 700 could be any of an electronic device or may be embodied in any of the electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 700 includes a controller or a processor 702 (e.g., a signal processor, microprocessor, ASIC, or other control and processing logic circuitry) for performing such tasks as signal coding, data processing, image processing, input/output processing, power control, and/or other functions. An operating system 704 controls the allocation and usage of the components of the electronic device 700 and provides support for one or more programs such as altering one or more access rights set on a digital document based on the triggering temporal events. The electronic device 700 is depicted to include one or more applications such as a document viewer application 706 facilitated by the server system 200. The document viewer application 706 can be an instance of an application downloaded from the server system 200 or a third-party server. The document viewer application 706 is capable of communicating with the server system 200 for facilitating alteration of one or more access rights set on a digital document, based on the triggering temporal events. The applications may include common computing applications (e.g., telephony applications, email applications, calendars, contact managers, web browsers, messaging applications such as USSD messaging or SMS messaging or SIM Tool Kit (STK) application) or any other computing application.

The illustrated electronic device 700 includes one or more memory components, for example, a non-removable memory 708 and/or a removable memory 710. The non-removable memory 708 and/or the removable memory 710 may be collectively known as storage device/module in an embodiment. The non-removable memory 708 can include RAM, ROM, flash memory, a hard disk, or other well-known memory storage technologies. The removable memory 710 can include flash memory, smart cards, or a Subscriber Identity Module (SIM). The one or more memory components can be used for storing data and/or code for running the operating system 704. The electronic device 700 may further include a user identity module (UIM) 712. The UIM 712 may be a memory device having a processor built-in. The UIM 712 may include, for example, a subscriber identity module (SIM), a universal integrated circuit card (UICC), a universal subscriber identity module (USIM), a removable user identity module (R-UIM), or any other smart card. The UIM 712 typically stores information elements related to a mobile subscriber. The UIM 712 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 700 can support one or more input devices 720 and one or more output devices 730. Examples of the input devices 720 may include, but are not limited to, a touch screen/a display screen 722 (e.g., capable of capturing finger tap inputs, finger gesture inputs, multi-finger tap inputs, multi-finger gesture inputs, or keystroke inputs from a virtual keyboard or keypad), a microphone 724 (e.g., capable of capturing voice input), a camera module 726 (e.g., capable of capturing still picture images and/or video images) and a physical keyboard 728. Examples of the output devices 730 may include, but are not limited, to a speaker 732 and a display 734. Other possible output devices can include piezoelectric or other haptic output devices. Some devices can serve more than one input/output function. For example, the touch screen 722 and the display 734 can be combined into a single input/output device.

A wireless modem 740 can be coupled to one or more antennas (not shown in the FIG. 7) and can support two-way communications between the processor 702 and external devices, as is well understood in the art. The wireless modem 740 is shown generically and can include, for example, a cellular modem 742 for communicating at long range with the mobile communication network, a Wi-Fi compatible modem 744 for communicating at short range with an external Bluetooth-equipped device or a local wireless data network or router, and/or a Bluetooth-compatible modem 746. The wireless modem 740 is typically configured for communication with one or more cellular networks, such as a GSM network for data and voice communications within a single cellular network, between cellular networks, or between the electronic device 700 and a public switched telephone network (PSTN).

The electronic device 700 can further include one or more input/output ports 750, a power supply 752, one or more sensors 754 for example, an accelerometer, a gyroscope, a compass, a global positioning system sensor (for providing location details) or an infrared proximity sensor for detecting the orientation or motion of the electronic device 700, a transceiver 756 (for wirelessly transmitting analog or digital signals) and/or a physical connector 760, which can be a USB port, IEEE 1294 (FireWire) port, and/or RS-232 port. The illustrated components are not required or all-inclusive, as any of the components shown can be deleted and other components can be added.

The disclosed method with reference to FIG. 6, or one or more operations of the method 600 may be implemented using software including computer-executable instructions stored on one or more computer-readable media (e.g., non-transitory computer-readable media, such as one or more optical media discs, volatile memory components (e.g., DRAM or SRAM)), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 102 and its various components such as the computer system 202 and the database 204 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method comprising:
accessing, by a server system associated with an application installed on a user device associated with a publisher, access rights information associated with a digital document stored by the publisher in a database, the access rights information comprising one or more access rights set on the digital document and access rights alteration rules;
restricting, by the server system, access to the digital document for one or more recipients in response to receiving access requests from one or more recipients based, at least in part, on one or more access rights;
monitoring, by the server system, occurrences of a plurality of the triggering temporal events based, at least in part, on a machine learning (ML) model; and
altering, by the server system, the one or more access rights set on the digital document based, at least in part, on the access rights alteration rules.

2. The computer-implemented method as claimed in claim 1, wherein altering one or more access rights set on the digital document comprises:
altering, by the server system, a set of access rights for at least one or more existing recipients of the digital document based on the access rights alteration rules; and
granting, by the server system, the one or more access rights to one or more new recipients of the digital document based on the access rights alteration rules.

3. The computer-implemented method as claimed in claim 1, further comprising:
providing, by the server system, a user interface to the publisher to set the one or more access rights and the access rights alteration rules for the digital document.

4. The computer-implemented method as claimed in claim 3, wherein the access rights alteration rules comprise information about the plurality of the triggering temporal events to be monitored, and wherein the access rights alteration rules specify allowing or denying of the one or more access rights to be performed based on the occurrence of at least one triggering temporal event or a predetermined time-schedule.

5. The computer-implemented method as claimed in claim 1, wherein one or more access rights specify that the one or more recipients are allowed or denied access rights such as: read the digital document, write the digital document, share the digital document, print the digital document, and download the digital document.

6. The computer-implemented method as claimed in claim 1, wherein monitoring the occurrences of a plurality of the triggering temporal events further comprises utilizing, by the ML model, at least one of internal and external information to determine occurrences of the plurality of the triggering temporal events.

7. The computer-implemented method as claimed in claim 6, wherein the ML model is a classification model.

8. The computer-implemented method as claimed in claim 1, further comprising:
receiving, by the server system, an access request for accessing the digital document from the one or more recipients; and
evaluating, by the server system, the access request based, at least in part, on the access rights set on the digital document by the publisher.

9. A server system, comprising:
a communication interface;
a memory comprising executable instructions; and
a processor communicably coupled to the communication interface, the processor configured to execute the executable instructions to cause the server system to at least:
access, access rights information associated with a digital document stored by a publisher in a database, the access rights information comprising one or more access rights set on the digital document and access rights alteration rules, wherein the server system is associated with an application installed on a user device associated with the publisher;
restrict access to the digital document for one or more recipients in response to receiving access requests from one or more recipients based, at least in part, on one or more access rights;
monitor occurrences of a plurality of the triggering temporal events based, at least in part, on a machine learning (ML) model, alter one or more access rights set on the digital document based, at least in part, on the access rights alteration rules.

10. The server system as claimed in claim 9, wherein the server system is further caused to:
alter a set of access rights for at least one or more existing recipients of the digital document based on the access rights alteration rules, and
grant one or more access rights to one or more new recipients of the digital document based on the access rights alteration rules.

11. The server system as claimed in claim 9, wherein the server system is further caused to provide a user interface to the publisher to set the one or more access rights and the access rights alteration rules for the digital document.

12. The server system as claimed in claim 11, wherein the access rights alteration rules comprise information of a plurality of the triggering temporal events to be monitored, and wherein the access rights alteration rules specify that altering of the one or more access rights is to be performed based on the occurrence of at least one triggering temporal event or a predetermined time-schedule.

13. The server system as claimed in claim 9, wherein the one or more access rights specify that the one or more recipients are allowed or denied access rights including: read the digital document, write the digital document, share the digital document, print the digital document, and download the digital document.

14. The server system as claimed in claim 9, wherein, to monitor the occurrences of a plurality of the triggering temporal events, the server system is further configured to utilize, via the ML model, at least one of internal and external information to determine occurrences of plurality of the triggering temporal events.

15. The server system as claimed in claim 14, wherein the ML model is a classification model.

16. The server system as claimed in claim 9, wherein the server system is further caused to:
receive an access request for accessing the digital document from one or more recipients; and
evaluate the access request based, at least in part, on the access rights set on the digital document by the publisher.
